(19) United States
(12) Patent Application Publication
(10) Pub. No.: US 2010/0216014 A1
(43) Pub. Date: Aug. 26, 2010

(54) Closure Assembly for Electrochemical Cells

(75) Inventors: Matthew T. Wendling, Avon, OH (US); Mark A. Schubert, Medina, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: EVEREADY BATTERY COMPANY, INC., St. Louis, MO (US)

(21) Appl. No.: 12/391,742

(22) Filed: Feb. 24, 2009

(51) Int. Cl. H01M 2/08

(52) U.S. Cl. 429/174; 29/623.2

(57) ABSTRACT

A closure assembly for an electrochemical cell includes a positive temperature coefficient (PTC) device and a dual wall gasket that isolates the PTC device from primary axial compression forces present in the closure assembly. A method for closing an electrochemical cell to remove the PTC device from primary axial compression is also contemplated.

### FIELD OF THE INVENTION

The present invention relates to a closure assembly for an electrochemical cell. More particularly, a primary lithium-containing electrochemical cell is disclosed. The cell has a closure assembly comprising a cover, a sealing gasket with variable diameter along its axial middle portion and a positive temperature coefficient (PTC) device, wherein the arrangement of the closure isolates the PTC from primary axial compression forces. A preformed seal assembly produced by insert molding the gasket around the cover.

### BACKGROUND OF THE INVENTION

A related patent application, also entitled “Closure Assembly for Electrochemical Cells” and having U.S. patent application Ser. No. ______, was filed on the same day as this application and is hereby incorporated by reference.

Electrochemical cells, including but not limited to those with a lithium metal or alloy as an electrochemically active material, often utilize one or more positive temperature coefficient (“PTC”) safety devices. These devices limit the current that can flow through the cell in order under certain conditions. For example, excess heat sufficient to activate the PTC device may be generated in an electrochemical cell as a result of external short circuit, attempting to recharge a primary cell, improperly charging a rechargeable cell, forced overdischarge, or improper installation of cells in a device.

Typically, PTC devices include a layer comprising a polymer and conductive particles such as carbon. When the temperature of the PTC device is increased above an activating temperature, the polymer thermally expands in a way that electrically disconnects the conductive particles dispersed within the PTC, thereby cutting off the flow of current through the PTC device. Consequently, electrochemical cell designs must allow for the thermal expansion of the PTC device.

Cylindrical electrochemical cells, such as AA and AAA sized batteries, are formed by a can (i.e., a cylinder with a closed bottom) and a cover and have an overall can height that is larger than the can's diameter. The electrical terminals of the battery are integrally formed on the bottom of the can and the cover. The container (i.e., the combination of the can and the cover) is then sealed by compressing a gasket or seal member between the cover and a portion of the open end of the can. In order to insure a hermetic seal, the compressive force should be maintained in both the axial and radial directions of the cylinder, usually by beading the can's sidewalls and then crimping the edge of the open end of the can over the cover. Insofar as the PTC device is often connected to the cover, this closure may subject the PTC device to compressive axial forces that adversely affect the activation of the PTC.

A common closure used in commercially available lithium-iron disulfide cells is shown in FIG. 6. Electrochemical cell 1 includes a cover 2 and PTC device 4 configured at a terminal end of the cell. Gasket 6 has an axial middle portion with a substantially uniform shape. The cover 2, PTC device 4 and contact assembly 8 (which includes both a rollback cover and a spring) are held, housed, or retained within the C-shaped gasket 6. Notably, axial force must be exerted to crimp the terminal edge of the can 3 during the sealing of the cell, thereby exposing the PTC device 4 to axial compressive forces during the closing operation itself. Moreover, because the crimped edge remains in place and the elastomeric gasket remains axially compressed, it will continue to axially constrict activation of the PTC (which requires the axial expansion of the PTC) throughout the life of the battery.

Various approaches have attempted to allow the PTC device to remove the PTC device from unwanted axially compression, thereby allowing it to expand upon activation. One such approach contemplates the use of additional conductive members, and/or spring-like devices, although this requires a substantial reconfiguration (and reduction in size) of the PTC device. Gasket materials that softens at a temperature below the activation of the PTC device have also been used, but this may eliminate the use of the best performing materials. Yet another approach is to locate the PTC outside of the container, but this requires a means for attaching the PTC to the can/cover and increases the likelihood of damage to the PTC.

U.S. Pat. No. 5,376,467 describes an organic electrolyte battery having a positive temperature coefficient resistor. In one embodiment, the PTC resistor is carried on a conductive annular member so that the PTC resistor is spaced radially inward, away from a crimping zone. In a second embodiment, it is disposed in the center of the lid and connected to the sealing member by a support member. In both instances, these arrangements necessarily require welding or adhesively fixing the PTC resistor to an additional conductive sealing member and the PTC resistor must have a diameter that is substantially smaller than the inner diameter of the battery can, thereby limiting the amount of surface area and overall effectiveness of the PCT resistor.

U.S. Pat. No. 5,766,790 relates to a safety device for use in a secondary battery that relies upon a series of disk-shaped springs. Internal pressure from the battery housing deforms the springs so as to break the electrical contact between the external terminal and one of the disk-shaped springs. Notably, this device requires numerous moving parts and relies solely on the internal pressure within the cell caused by overheating the electrolyte, rather than being activated by the electrical demands (i.e., the load) placed on the cell.

U.S. Pat. No. 6,531,242 and Japanese Publication No. 05-151944 disclose the use of multiple gaskets in a battery seal. These gaskets work together to minimize the compressive forces exerted on the PTC device. In the former, a series of nested gaskets cooperate in conjunction with a lead plate and the PTC device. In the later, two separate gaskets are provided, with the gasket that comes into contact with the PTC device having a lower melting point than the activation temperature of the PTC device, thereby insuring the PTC device can expand as necessary into the softened gasket. The inclusion of additional parts (e.g., two or more gaskets) increases manufacturing complexity and cost.

U.S. Pat. No. 6,620,544 discloses and electrochemical cell that relies upon a metal foam “shock absorber” and a separate insulating ring both positioned proximate to the PTC device. Here, the metal foam allows for expansion of the PTC device upon activation, while the insulating ring is thicker than the PTC device to allow for proper spacing of the parts when the cell is sealed. As with U.S. Pat. No. 5,376,467 above, this arrangement requires the use of a smaller diameter PTC device.

Finally, Japanese Publication No. 10-162805 contemplates providing a PTC device along the central axis of the cell. Here, the PTC device avoids exposure to crimping forces by limiting its overall diameter, although this limited diameter reduces the effectiveness of the PTC device by limiting the amount of surface area in contact with the electrode. Moreover, this central location of the PTC device prevents the inclusion of common venting devices. Finally, as noted in the reference, some embodiments of this arrangement permit the PTC device to be in contact with the organic electrolyte contained within the cell housing. In such instances, the PTC device must not react with or dissolve in the organic solvents, thereby presenting a significant technical challenge in terms of chemical compatibility.

### SUMMARY OF THE INVENTION

In view of the above, the invention contemplates, inter alia, a lithium electrochemical cell design with a PTC device that has the ability to limit current flow therethrough at desired temperatures (typically occurring under abusive conditions), while at the same time not limiting the ability of the PTC device to activate and without substantially reducing its surface area or shape. Additionally, this cell design maintains reliable, compressive sealing forces over extended periods of time both before and after activation of the PTC device and without directly exposing the PTC device to the organic solvents of the electrolyte.

The PTC devices in this invention typically experience a phase change to limit current flow at temperatures between 85° C. and 175° C. Ultimately, the preferred activation temperature for the PTC will be dictated by the design, as well as the melting point of the other cell materials (e.g., the gasket polymer(s)) and/or the temperature at which the cell may vent. As noted above, the surface area of the PTC disposed within the electrical pathway of the battery (i.e., between the electrode and the terminal) should be maximized to insure the most efficient utilization of the PTC.

The cell design includes a closure assembly affixed to the open end of a battery container. The closure assembly includes the PTC and forms an effective barrier to electrolyte vapor transmission that insures the battery will not explode when subjected to abusive conditions such as overcurrents or excessive temperatures. The design of the closure assembly exerts radial and axial forces primarily within the sealing gasket to prevent electrolyte egress and moisture ingress, but the PTC device present in the end assembly is partially or completely shielded from primary axial compression forces without interfering with the venting mechanism. Notably, the gasket must be made of a material that is electrically insulating, resistant to chemical degradation by the electrolyte and impervious to cold flow or loss of its structural and mechanical integrity over long periods of time. Insert molding may be use to integrate the gasket directly into another component such as the container or closure assembly, or more particularly the cover or rollback cover of the closure assembly.

By altering the cross sectional shape of the sealing gasket, the PTC device is removed from the compressive forces necessary to effectively seal the battery, both during manufacturing and the subsequent storage/use of the battery. This arrangement allows the PTC device to: i) avoid damage during manufacture, ii) expand during activation and iii) reduce electrical resistance by maximizing the surface area for electrical connection between the internal electrode of the battery and the external terminal of the battery housing.

Specifically, the annular seal member (i.e., the sealing gasket) has a constant outer diameter along an axial section, but an interior surface in that section with at least two different diameters. The terminal cover is concentric to a portion of the gasket having one diameter and the PTC device is concentric to the portion of the seal member having a different diameter. Thus, the gasket has a plurality of radial shoulders or steps wherein the terminal cover is seated on the top surface of a first step and the PTC is directly or indirectly (by virtue of its connection to other components of the end assembly) seated on the top surface of a second step. Thus, in the final end assembly of a sealed cell, the cross-section of the gasket itself will have an axial portion having at least two distinct regions with differing thicknesses, thereby imparting a “dual wall” or cross-sectionally stepped shaped along the middle portion. Upper and lower flanges can be situated in or adjacent to this middle portion, with the upper flange being crimped over the top of the terminal cover (i.e., the terminal cover is sandwiched between the crimp, on its top, and the step, on its bottom) and the lower flange integrally forming one of the steps, and possibly extending downward beyond the middle portion.

In every instance, the closure assembly is formed to create two axial compression zones: a primary zone and a secondary zone (i.e., respectively speaking, a zone underneath the crimp where axial compression is exerted and a zone concentrically adjacent to the second wall of the gasket where minimal compression is exerted). The primary zone is responsible for maintaining the closure seal of the cell, and it can be affected by the crimp or the crimp working in conjunction with an annular bead made in the sidewall of the container. The secondary zone has less compressive force than the primary zone. In this manner, the PTC device is exposed to less axial compression force than the other respective parts of the closure assembly, thereby avoiding damage to PTC device and also allowing it to activate without constraint. Notably, a gasket material must have sufficient rigidity to permit formation of these high and low compression zones, and use of a single injection molded thermoplastic material for the dual wall gasket is advantageous because it allows for mass production of the part while avoiding material compatibility and related issues.

This gasket is incorporated into a closure assembly, as noted above. The closure assembly will typically nest within the open end of the container. A bead may be made along the circumference of the container just below the closure assembly to insure better sealing between the end assembly and the container. The lower flange, if present, would be adjacent to the bead and may even extend partially or completely around it. The closure assembly itself comprises a cover, a gasket whose axially middle portion has a variable diameter, a PTC device, a venting mechanism and an optional “rollback” cover that is typically an integral part of the venting mechanism (e.g., a disk-shaped sealing plate with an axial protrusion to maximize and maintain both axial and radial compression between the end assembly and the container). The venting mechanism may be a ball vent or a foil vent. A lead or contact spring makes contact with, and may even be incorporated into, the closure assembly in a manner that creates an electrical connection flowing from the battery electrode, through PTC and the cover(s) and ultimately to the integrally formed terminal on the exterior of the battery itself.

Ultimately, a complete description of the invention, including its various features and embodiments, can be found by referencing the description and claims below.

### BRIEF DESCRIPTION OF THE DRAWINGS

The invention will be better understood and other features and advantages will become apparent by reading the Detailed Description of the Invention, taken together with the drawings, wherein:

FIG. 1 is a cross-sectional view of one embodiment of the invention illustrating a closure assembly with a ball vent mechanism and a gasket having multiple axial compression zones;

FIG. 2 is a cross-sectional view of a further embodiment of FIG. 1;

FIG. 3 is a cross-sectional view of one embodiment of the invention illustrating a closure assembly with a foil vent mechanism and a gasket having multiple axial compression zones;

FIG. 4 is a cross-sectional view of one embodiment of the invention illustrating a closure assembly with a coin vent mechanism and a gasket having multiple axial compression zones;

FIG. 5 is cross-sectional view of a yet another embodiment of FIG. 3 or 4;

FIG. 6 is a cross-sectional view of a prior art closure assembly; and

FIG. 7 is a cross-sectional view of one embodiment of the invention illustrating the axial compression force and the varying diameters of the gasket, which may be applicable to any of the embodiments illustrated in FIGS. 1-5.

### DETAILED DESCRIPTION OF THE INVENTION

As used throughout this specification, the term “electrochemical cell” is afforded a broad meaning, including any system capable of producing electrical current with a positive electrode, a negative electrode, a separator and an electrolyte, although the invention is most applicable to systems using nonaqueous electrolytes. A cylindrical container is any tubular container, with at least one open end, whose axial height is greater than its diameter. A “shoulder” or “seat” is a horizontally oriented feature which is designed to receive, support and hold in place the component(s) which are seated on the shoulder; as such, a shoulder is structurally and functionally distinct from a crimped flange or a flange that primarily extends in an axial direction of the cell.

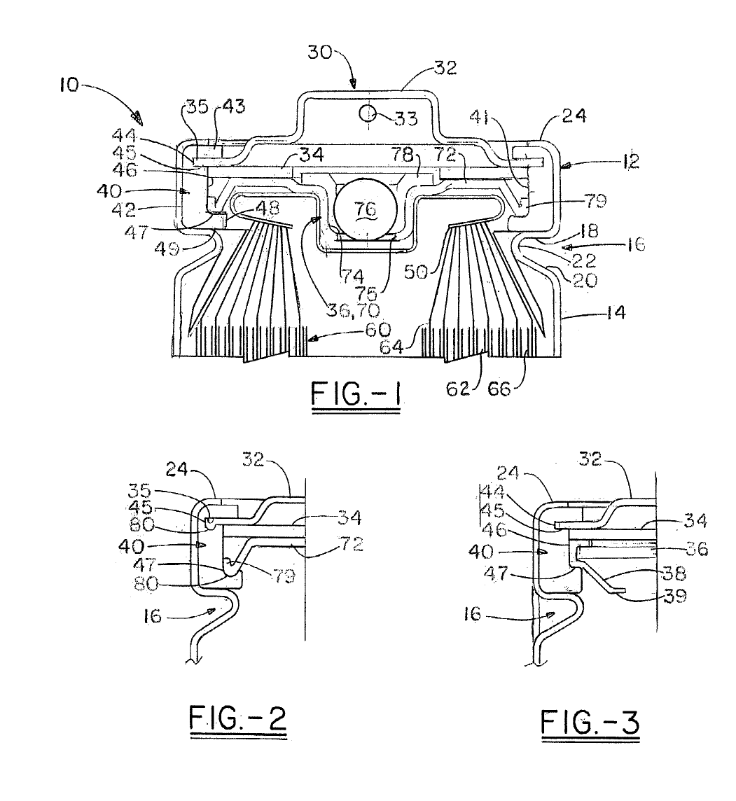

The invention relates to electrochemical cells, preferably containing lithium or lithium alloy as an electrochemically active material and a non-aqueous electrolyte, with a cell closure assembly including a cylindrical container having an open end sealed by an end assembly including a pressure release vent member capable of venting when the internal pressure of the cell is at or above a predetermined pressure. The invention will be better understood with reference to the drawings, wherein FIG. 1 illustrates one embodiment of a cylindrical electrochemical cell 10 of the present invention. Cell 10 is a primary FR6-type cylindrical Li/FeS₂ cell. However, it is to be understood that the invention can be applicable to other cylindrical battery chemistries and cell designs.

Cell 10 has a housing 12 that includes a container 14 in the form of a can with a closed bottom and an open top end into which a closure assembly is fitted. The mechanical strength, closing/sealing requirements and internal cell designs associated with cylindrical cells are markedly different from those of coin or button cells, especially insofar as a cylindrical shapes posses the superior hoop strength and do not experience axial swelling commonly encountered in coin and button cells.

The open top end of container 14 is closed with an end assembly 30 that cooperates with the open top end. The container 14 has a circumferential inward projection or bead 16 near the top end of the container that supports a portion of the end assembly 30. Bead 16 is generally considered to separate the top and bottom portions of the container 14. The closure assembly including container 14 and end assembly 30 fits within the top portion of container 14 and seals the electrode assembly 60 within the bottom portion of the container 14. The electrode assembly 60 shown here is a “jellyroll construction” that includes an anode or negative electrode 62, a cathode or positive electrode 64 and a separator 66 spirally wound together. One or multiple layers of separator 66 may be used to allow ionic conduction and prevent direct electrical contact between the electrodes 62, 64. Electrolyte is also disposed within the container 14.

The container 14 can be one of several geometric shapes for open-ended containers, for example, prismatic and rectangular containers, provided that the teachings regarding the closure assembly are followed. As the sealing of an open-ended cylindrical cell presents challenges regarding the radial and axial forces required to create the seal, the end assembly 30 which cooperates with the container 14 to minimize vapor transmission is expected to have particular applicability to cylindrical containers.

Container 14 is preferably a metal can having an integral closed bottom. However, a metal tube that is initially open at both ends may be used in some embodiments. Container 14 in one embodiment is steel that is optionally plated, for example, with nickel on at least the outside to protect the exposed surface of the container from corrosion or to provide a desired appearance. For example, the can may be made of cold rolled steel (CRS), and may be plated with nickel on at least the outside to protect the outside of the can from corrosion. Typically, CRS containers according to the invention can have a wall thickness of approximately between 7 and 10 mils for a FR6 cell, or 6 to 9 mils for a FR03 cell. The type of plating can be varied to provide varying degrees of corrosion resistance, to improve the contact resistance or to provide the desired appearance. The type of steel will depend in part on the manner in which the container is formed. For drawn cans, the steel can be a diffusion annealed, low carbon, aluminum killed, SAE 1006 or equivalent steel, with a grain size of ASTM 9 to 11 and equiaxed to slightly elongated grain shape. Other metals may be used to meet special needs as is known in this art; for example, stainless steel may be used when the open circuit voltage of the cell is designed to be greater than or about 3 volts, or when the cell is rechargeable in order to provide relatively greater corrosion-resistance. Examples of alternative container materials include, but are not limited, stainless steels, nickel plated stainless steels, nickel clad stainless steel, aluminum and alloys thereof.

As illustrated in FIGS. 1 and 2, bead 16 is an inward projection, preferably extending circumferentially around the cylindrical container. Bead 16 has an upper wall 18, a lower wall 20 and transition member 22 which connects the upper wall 18 to lower wall 20. Upper wall 18 can be inclined upwardly towards the radial center of the cell. The bead 16 provides the desired axial compression between the upper wall 18 and the crimped end 24 of container 14. Ultimately, bead 16 is provided to help create and maintain axial closing forces during and after the sealing of the container 14 and end assembly 30. Further details on the bead can be found in U.S. patent application Ser. No. 12/136,910 (United States Publication No. pending), filed on Jun. 11, 2008, which is incorporated by reference herein.

The end assembly 30 is disposed in the top portion of container 14 and includes a terminal cover 32 having a conductive contact that serves as one of the cell's terminals, a PTC device 34 that limits or interrupts current flow through the cell, a rupturable pressure release vent mechanism 36, a gasket or seal member 40 and a contact member 50 such as a welded lead or spring that defines an opening as illustrated in the arrangement of FIG. 1. An electrically insulating polymeric gasket 40 may be positioned between the container 14 and the components of the end assembly 30, such that the end assembly 30 has a polarity that is different from that of the container 14.

The PTC device 34 is disposed in an electrical path between the contact terminal cover 32 and the positive electrode 64 of electrode assembly 60. Thus, when the PTC device is activated by abusive conditions, electrical current flowing from the electrode assembly 60 to the terminal cover 32 is severely restricted, if not completely eliminated. In this manner, the PTC protects the cell 10 from damage or disassembly when the cell is exposed to abusive conditions such as over-current and/or over-temperature conditions caused by, for example, external short circuiting of the cell, abusive charging, reverse installation or forced discharge. The conductive contact terminal 32 preferably protrudes above the end of container 14 and is held in place by the inwardly crimped end 24 of container 14 with insulating gasket 40 disposed therebetween. As noted above, the crimped end 24 exerts axial closing force. This crimp is performed in the closing operation of cell 10; that is, the container 14 is beaded with the end assembly 30 fitted in place, then the end 24 is crimped to create axial compression as described above.

Electrochemical cells, and particularly those that include lithium or a lithium-based alloy, may be subjected to abusive conditions (e.g., elevated temperature, overcurrent, etc.) caused by internal or external short circuits, unintended charging, malfunctioning or poorly designed devices and the like. Thus, PTC device 34 is a key safety component in cell 10. PTC device 34 is a resettable device exhibiting positive temperature coefficient behavior wherein the electrical resistance of the device increases with an increase in temperature.

In one preferred embodiment, the PTC device 34 comprises a polymer having conductive particles dispersed therein. Specifically, the PTC device 34 comprises polyethylene and electrically conductive particles such as carbon. Other types of particles, such as conductive metals, for example nickel can also be utilized. Below the typical operable temperature range of 85-170° C. for most PTC and the more preferred temperatures of between approximately 85-125° C. (which coincides with the desired maximum operating temperature range for most consumer electrochemical cells), the conductive dispersed particles in the PTC form a relatively low resistance electrical path through the polymer. The lower end of the general temperature range is dictated by desire for the cell to function at a temperature of about 85° C. The upper end of the general temperature range is dictated by the melting point of cell components, such as the seal and electrochemically active materials. The ability of the PTC device to trip depends on compression on the PTC and other factors, including density of the PTC device.

If or when the temperature of the PTC device 34 rises above a switching temperature (also referred to as herein as “activation” of the device), the polymer changes phase. This phase change increases the volume of the polymer such that most of the dispersed conductive particles separate, breaking the low resistance electrical path and dramatically increasing the resistance of the PTC device. As the resistance increases, the amount of current that can flow through the PTC device is reduced. When the temperature of the PTC device is decreased to the operating range, the polymer recrystallizes and conductive particles move closer in proximity to one another and restore the low-resistance state of the PTC device.

A preferred PTC device 34 for cylindrical electrochemical cells comes in the shape of an annulus with a central aperture for allowing fluid to pass therethrough. In particular, the aperture accommodates a venting mechanism to insure that explosive pressures do not build up within the sealed container. However, the amount of surface area of the PTC which forms the electrical path should be maximized to help minimize the resistive effect of the PTC on the cell itself. Thus, preferred PTC devices have a diameter that is relatively close to the maximum diameter permitted by the container, while the central aperture is minimized. Appropriate PTC devices are commercially available from numerous sources. Suitable PTC device are sold by Boums, Inc. of Riverside, Calif., USA, and Tyco Electronics in Menlo Park, Calif., USA.

PTC devices add to the internal resistance of the cell. Typically, this added resistance should not exceed approximately 36 mΩ in a AA form factor, and lower resistance devices of approximately 18 mΩ in a AA form factor are now becoming available. Optimally, the device will limit a voltage of up to 15 V DC and a current of up to 20 A. The diameter of the PTC should correspond to the diameter of the end assembly as discussed in greater detail below. The vent aperture should be sized to cooperate with the venting mechanism, with a diameter between 2.5 and 5.5 millimeters being appropriate. The thickness (or “axial height” as used below) of the PTC device should range between about 0.25 and 0.50 millimeters (1 to 2 mils) and more preferably between 0.30 and 0.35 millimeters, depending upon the exact configuration of elements in the end assembly 30.

A problem with maintaining the PTC device 34 in the end assembly 30 is that a seal must be maintained between the container 14 and the end assembly 30 to prevent leakage of the cell electrolyte. As the seal is typically formed utilizing pressure, generally by forming a compression seal between the container 14 and end assembly 30, in both the axial and radial directions of the cell, the PTC device 34 can be subject to compressive forces that are necessary to insure a reliable seal is formed. However, compression of the PTC device 34 by the end assembly 30 and container, and more specifically by the combined axial compression effects of the crimped end 24, the rigidity of the gasket 40 and the upper wall 18 of the bead 16, can limit expansion and thereby affect its performance. Challenges of the invention are thus to provide the PTC device in the end assembly; to isolate the PTC device from contact with the electrolyte (thereby impacting activation of the PTC device), ambient environment outside the cell and external physical contact (to prevent shorting around the active portion) and to minimize compression in the PTC device while maintaining the PTC in a desired position within the cell to allow for desired expansion on activation (and thus the ultimate desired performance of the PTC device). Use of less rigid polymer materials, as suggested by the references discussed above, can lead to unwanted cold flow of the gasket, leakage of the electrolyte and generally unacceptable seal performance for end assembly 30. Moreover, the material of the gasket must have sufficient rigidity to meet the criteria described herein.

In order to allow the PTC device 34 to achieve a desired expansion, the PTC device 34 is located in the end assembly 30 so as to remove it from the primary axial compression forces. The term primary axial compression force is defined herein as the greatest or maximum axial pressure exerted along the axis of the cylindrical container during the sealing of the end assembly 30, as well as the resulting compressive force maintained in the sealed cell. For example, FIG. 7 illustrates a primary axial compression force on an axial line extending through line A-A, and the axial compression zone is bounded by the upper wall 18 of bead 16 and the crimped end 24 of container 14, although the precise amount of force exerted depends, in part, on the material of the container, the crimp conditions and the rigidity of the material of the gasket. However, it will be understood that lesser (or, as used herein, “secondary”) axial compression is still exerted throughout the components of the end assembly. The amount of force will be less than the primary compression zone, thereby allowing activation of the PTC device.

As noted above, the PTC device 34 has an annular construction with the outer diameter or periphery of the PTC device 34 located concentrically within one of the discrete axially extending wall sections of the gasket 40. That is, the PTC is radially inward from the primary axial compression force exerted on the cell closure assembly. By virtue of this location in the cell, the PTC is in the zone of secondary axial compression This zone includes the components bounded by portion of the terminal cover 32 that are radially concentric to the crimped end 24, the PTC device 34 and the vent mechanism 36.

A preferred construction for lessening axial pressure on the PTC device 34 includes a gasket 40 that is: i) nonconductive and isolates desired cell components of opposite polarity, and ii) formed from a plastic that is reliably compressible to aid in forming a sealed closure assembly but resistant to cold-flow or other unwanted deformation. The thermoplastic used to mold gasket 40 must also maintain sufficient rigidity, even when exposed to the activation temperature of the PTC device 34. Seal member 40 is formed as a hollow cylinder or annulus having variable dimensions along its axial length. These variable dimensions impart a concentric set of radial protruding shoulders or a “stepped” configuration to the gasket. That is, the seal member 40 has an outer surface 42, with a consistent outer diameter along its entire axis. The outer surface 42 in the closed cell substantially conforms to the configuration of the inner surface of container 14 adjacent the seal member 40 to provide a barrier in order to minimize the entry of water into the cell and loss of electrolyte from the electrochemical cell.

An upper flange 43 is preferably initially formed as an upwardly extending segment, wherein a portion of the upper end 43 is bent inwardly when the crimped end 24 of container 14 is formed. As shown in FIG. 7, the final crimped flange defines a diameter along line 1R-1R. This diameter must exceed the diameter of the inner surface 44 (line 2R-2R), which is described in greater detail below.

The gasket 40 also has a stepped inner diameter. Inner surface 41 of the gasket 40 has a diameter defined by the line 3R-3R in FIG. 7, while inner surface 44 has a diameter defined by line 2R-2R. The diameters of the inner surfaces 41, 44 are not the same, which necessitates the inclusion in gasket 40 of at least one radial shoulder or seat 45. Seat 45 engages and cooperates with various components of the end assembly 30 to form a hermetic seal between the end assembly, the gasket and the container. Lower flange 48 of the gasket may form a second seat 47 to engage the end assembly 30. Seat 45 may engage the terminal cover 32, while seat 47 may engage the vent mechanism 36 (or, in one embodiment, the rollback cover 79). As with the other components defining the dual wall of gasket 40, lower flange 48 is defined by a diameter, shown as line 4R-4R in FIG. 7, that is not the same as the diameter of inner surface 41. In a one embodiment shown in FIG. 7, the diameter of the upper flange 43 is less than the diameter of inner surface 44 and the diameter of lower flange 48 is less than the diameter of inner surface 41.

With reference to the drawings and FIG. 1 in particular, one of the inner surfaces 41, 44 will concentrically encase the periphery of the terminal cover 32, while the other will concentrically encase the periphery of PTC 34. Vent mechanism 36 may also be encased and/or in contact with one of the seats 45, 47. In the sealed cell, i.e., completed cell suitable for use, the terminal cover 32 has a peripheral portion that contacts the inner surface 44 so as to establish radial compression between the container 14 and the terminal cover 32. Additionally, upper flange 43 cooperates with crimped end 24 to exert axial compression on the portion of terminal cover 32 that is engaged on the seat 45 (note this axial compression extends down through the gasket 40 onto the upper wall 18 of the bead 16). In contrast, PTC 40 is offset from this primary axial compression zone, but still held in place by terminal cover 32 on one side and the radial sealing portion 72 of vent mechanism 36 on the opposite side. As such, PTC 40 is in the secondary compression zone which allows for volumetric expansion of the PTC upon activation irrespective of the rigidity of the gasket material. Notably, upon closure of the cell, sufficient radial force will also be exerted on the container 14 by closure assembly 30, although this radial force will have negligible impact upon the performance/activation of the PTC.

The configuration of the seal member 40 provides for multiple radial and axial compression areas, both primary and secondary axial compression areas, between the closure assembly components, namely the container 14 and the end assembly 30 including the seal member 40. The design is adapted to reduce the ability of electrolyte vapor to escape from the cell as well as reduce the ability of water to enter the cell, and further to isolate the PTC device 34 from the primary axial compression forces of the closure assembly.

In view of the foregoing, it should be evident that primary axial compression forces are exerted on a stack of components of the closure assembly including crimped end 24 of container 14, seal member 40, terminal cover 32, vent mechanism 36 and upper wall 18 of bead 16; and the PTC device 34, due to its location in the cell, is not subjected to the primary axial compression forces. While FIG. 1 illustrates step 45 as being substantially perpendicular to the sidewall of the container 14 (as well as the outer sidewall of the gasket 40), it may be possible to angle or taper the shoulder so long as the desired offset to remove the PTC from the primary axial compression zone is achieved.

The seal member 40 is made of a material composition that can form a compression seal with other cell components of the closure assembly and it also has low vapor transmission rates in order to minimize, for example, the entry of water into the cell and loss of electrolyte from the electrochemical cell. The seal member 40 can include a polymeric composition, for example, a thermoplastic polymer, composition of which is based in part upon factors such as chemical compatibility with the components of the electrode assembly, namely the negative electrode, positive electrode, as well as the electrolyte, such as a non-aqueous electrolyte utilized in the electrochemical cell 10. The seal member is made from any suitable material that provides the desired sealing and insulating properties. The seal member material must maintain sufficient rigidity that is greater than the rigidity of the PTC device (i.e., upon closing of the cell, the gasket material must not be so compliant as to fail to shield the PTC device from primary axial compression). Examples of suitable materials include, but are not limited to, polyethylene, polypropylene, polyphenylene sulfides, tetrafluorideperfluoroalkyl vinyl ether copolymer, polybutylene terephthalate, ethylene tetrafluoroethylene, polyphthalamide, or any combination thereof. Owing to their superior rigidity, preferred gasket materials are polyphthalamides (e.g., Amodel® ET 1001 L from Solvay Advanced Polymers of Alpharetta, Ga., USA) or possibly polyphenylene sulfides (e.g., TECHTRON® PPS from Boedeker Plastics, Inc., Shiner, Tex., USA), both described in United States Patent Publication Nos. 20050079404 and 20050079413, are hereby incorporated by reference. The seal member compositions can optionally contain reinforcing fillers such as inorganic fillers and/or organic compounds.

The seal member 40 may be coated with a sealant to further enhance sealing properties. Ethylene propylene diene terpolymer (EPDM) is a suitable sealant material, but other materials can be used.

The conductive terminal cover 32 can be provided with one or more vent apertures 33 to allow release of fluid if vent mechanism 36 is breached. Terminal cover 32 can be made from the same or similar materials as those identified as being appropriate for the container. Ultimately, the terminal cover should have good resistance to corrosion by water in the ambient environment, include a conductive portion with good electrical conductivity, and when visible on consumer batteries, have an attractive appearance. Conductive portions of the terminal cover are often made from nickel plated cold rolled steel or steel that is nickel plated after the cover has been formed.

Pressure release vent mechanism 36 is present so that the cell contents can be substantially contained within the electrochemical cell 10 below a predetermined pressure. The pressure release vent mechanism 36 can be, for example, a ball vent or a foil vent. Gases are generated within the cell due to environmental conditions such as temperature and, in certain instances, generated during normal operation through chemical reactions. When the pressure within the electrochemical cell is at least as high as a predetermined release pressure, a portion of the vent mechanism 36 ruptures and allows fluid, in the form of liquid or gas or a combination thereof, within the cell to escape through the opening created in the vent mechanism 36. The predetermined release pressure can vary according to the chemical composition of the cell. The predetermined pressure is preferably above a pressure which will avoid false vents due to normal handling and usage or exposure to the ambient atmosphere. For example, in a FR6-type lithium-containing electrochemical cell, the predetermined release pressure, for example the pressure at which the vent mechanism 36 creates an opening, for example, via rupturing, can range from about 10.5 kg/cm² (150 lbs/in²) to about 112.6 kg/cm² (1600 lbs/in²) and in some embodiments, from about 14.1 kg/cm² (200 lbs/in²) to about 56.3 kg/cm² (800 lbs/in²) at room temperature, about 21° C. The pressure at which the pressure release vent mechanism 36 ruptures can be determined by pressurizing a cell, e.g., through a hole punctured in the container. Examples of a foil vent design can be found in United States Patent Publication Nos. 20050244706, 20060228620 and 20080213651, all of which are incorporated by reference.

The vent mechanism 36 illustrated in FIG. 1 is a ball vent. Ball vent 70 includes a radial sealing portion, a central vent well 74 and a vent aperture 75 sealed by a vent ball 76. Vent bushing 78 may be made from a thermoplastic material similar to those described as appropriate for the gasket above. The vent bushing 78 allows sufficient compressibility the vertical walls of the vent well 74 and the periphery of the vent ball 76 to maintain a hermetic seal under normal (i.e., non-abusive) conditions. When the cell internal pressure exceeds the predetermined level, the vent ball 76 or both ball 76 and bushing 78 are forced out of the aperture 75 to release pressurized fluid from the cell 10.

Vent sealing portion 72 terminates at its periphery with a U-shaped wall (also referred to as a “rollback cover”) 79. The rollback cover 79 engages the gasket 40 as described above. The configuration of the peripheral wall 79 aids in forming an electrolyte migration barrier and possesses spring-like characteristics and aids in providing radial compression with seal member 40 in conjunction with the adjacent sidewall or container 14. The electrochemical cell may includes a conductive contact member 50 electrically connected to the vent mechanism 36, and more specifically to one or both of the radial sealing portion 72 and rollback cover 79. As such, these portions of the vent must be electrically conductive. Container 14, seal member 40 and vent mechanism 36 cooperate to maintain the electrode assembly 60 and electrolyte in the lower portion of container 12.

The vent ball 76 can be made from any suitable material that is stable in contact with the cell contents and provides the desired cell sealing and venting characteristics. Glasses or metals, such as stainless steel, can be used. The vent ball should be highly spherical and have a smooth surface finish with no imperfections, such as gouges, scratches or holes visible under 10 times magnification. The desired sphericity and surface finish depends in part on the ball diameter.

FIG. 2 illustrates a further embodiment of the present invention, wherein the seal member 40 is provided with one or more circumferential grooves or recesses 80 on one or both of the seats 45, 47. In the embodiment illustrated, terminal cover 32 has an axially extending protrusion 35 which engages recess 80 in seat 45. Likewise, recess 80 in seat 47 engages rollback cover 79. The shape of recesses should be complimentary to the profile of the corresponding parts so as to insure reliable placement of the inner cover 72 within the end assembly 30.

A further embodiment of the present invention set forth in FIG. 3, which includes a vent mechanism 36 and is specifically a foil vent. As utilized in the present invention, the term foil vent refers to a vent construction having one or more layers and includes, for example, a laminate foil vent having two or more different layers, with a portion of the foil vent being rupturable in response to being subjected to at least a predetermined amount of pressure. Vent mechanism 36 illustrated in FIG. 3 is a laminate type foil vent having a central area adapted to rupture upon being subjected to a predetermined pressure from within the cell, namely the compartment housing the electrode assembly.

As illustrated in FIG. 3, a electrical contact member 38 can be considered as a discrete component of the vent mechanism 36 that is electrically connected to the conductive contact terminal 32 via PTC device 34 on one side and to the electrode assembly 60 on the opposite side (not illustrated). Ultimately, the contact member 38 has a shape that conforms to the gasket 40 (and specifically the inner wall and seat), the vent mechanism 36 and the terminal cover 32. The “sideways J” shape shown in FIG. 3 is one preferred embodiment, where the top end of the member 38 is oriented along a substantially radial plane to maximize the surface area in contact with the PTC 34 (thereby reducing resistance), while the tab or lower leg 39 of member 38 extends both axially and radially into the interior of the container 14 in order to establish electrical contact with one of the electrodes (typically, the positive electrode). For example, the current collector of the positive electrode 64 may be an electrically conductive substrate, such as copper, aluminum or other metal foil or mesh, that extends beyond the positive electrode materials and the separator 66. Electrochemically active positive electrode material(s) are then coated onto this substrate.

Contact members 38 and 50, if used, can be made of one or more conductive materials, preferably having spring-like characteristics, although any component which makes and maintains a sufficient electrical contact with the desired components can be utilized. These members 38, 50 may simply maintain a pressure contact with the electrode assembly 60, or they may make a fixed connection, via welding, adhesion or otherwise, with the assembly 60.

When the end assembly 30 is placed into container 14 during assembly, the current collector is biased against tab 39 of contact member 38 which, as indicated above, is resilient and/or resistant to force. The characteristics of tab 39 aid in maintaining contact between contact member 38 and current collector. Optionally, the tab 39 can be welded to the current collector, maintain contact via spring-force or through the use of an intermediary conductive lead, such as a narrow metal strip or wire that can be welded to both the tab 39 and current collector. Welded connections can sometimes be more reliable, especially under relatively harsh handling, storage and use conditions, but pressure connections do not require additional assembly operations and equipment.

As illustrated in FIG. 3, vent mechanism 36 is disposed in the opening defined by the peripheral flange of the contact member 38. More specifically, the vent mechanism 36 periphery is secured by the folded end of the peripheral flange of contact member 38. The seal between the vent mechanism 36 and contact member 38 can be the result of tight pressure contact at the interfacial surfaces, which can, in some embodiments, be enhanced by axial compression of the peripheral portion of the vent mechanism 36. Optionally, an adhesive or sealant can be applied to the desired interfacial surfaces to connect the vent mechanism 36 to contact member 38 and thereby form a desired seal. Primary axial compression forces generated during crimping or closing of the container 14 during assembly of the cell are also placed on the peripheral portion of a vent mechanism 36 and contact member 38.

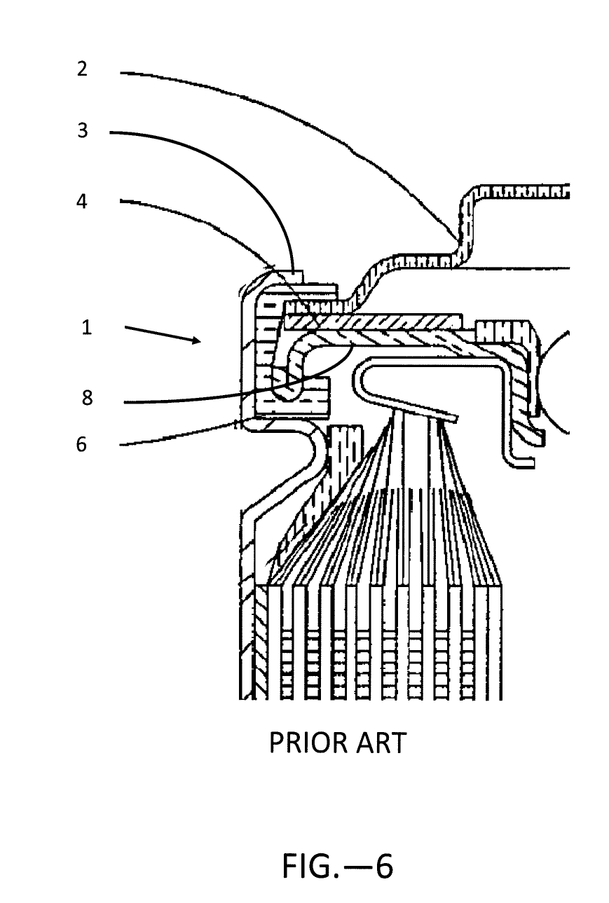

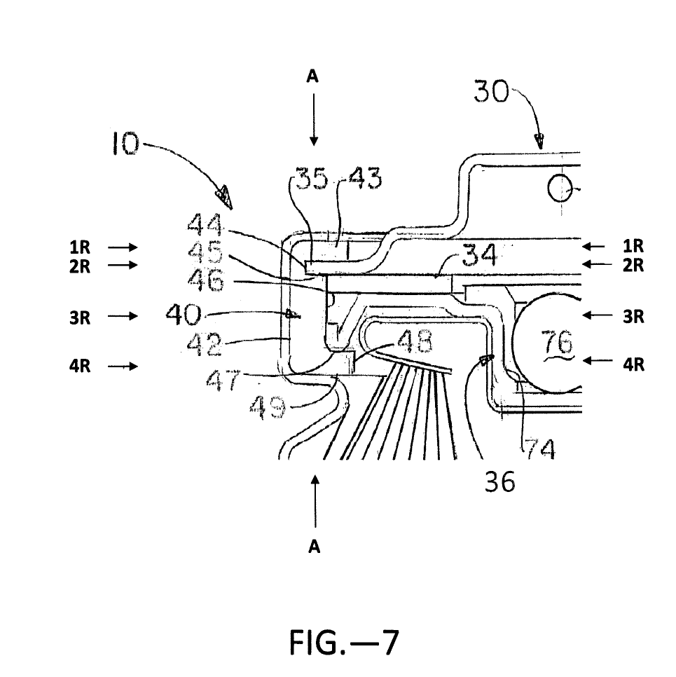

FIG. 5 illustrates a further embodiment of the present invention with particular applicability to the use of a foil vent as the vent mechanism 36. Here, a retainer cup 88 is utilized to form a subassembly sandwiching the foil vent (generically designated as vent mechanism 36) and contact member 38. Thus, retainer 88 engages the seat 47 of gasket 40. Retainer 88 is formed including a conductive material which is disposed in the electrical path between contact member 38 and PTC device 34. Use of such a retainer may simplify manufacturing processes.

The foil-type pressure release vent mechanism 36 shown in FIG. 3 includes at least one layer of a composition of metal, polymer, or mixtures thereof. It is also possible that the foil-type pressure release vent mechanism 36 can include two or more layers of different material compositions. For example, a second layer having a different composition than a first layer may be used for purposes of bonding the pressure release vent mechanism 36 to a retainer 88 such as shown in FIG. 5, or to the contact member 38. In another example, a second and a third layer having a different composition than the first layer may be used to bond the pressure release vent mechanism 36 to both the retainer 88 and the contact member 38. Also, multiple layers having two or more compositions can be used for tailoring the performance properties, for example, strength and flexibility, of the pressure release vent mechanism 36. Ideally, separate layers would be provided on the basis of compatibility with the electrolyte, ability to prevent vapor transmission and/or ability to improve the sealing characteristics of the vent mechanism 36 within the end assembly. For example, an adhesive activated by pressure, ultrasound and/or heat, such as a polymer or any other known material in the adhesive field that is compatible with the elements disclosed herein, could be provided as a layer of the vent mechanism 36 in order to bond the vent member within the end assembly.

Compositions suitable for use in the foil-type pressure release vent mechanism 36 can include, but are not limited to, metals such as aluminum, copper, nickel, stainless steel and alloys thereof; and polymeric materials such as polyethylene, polypropylene, polybutylene terephthalate (PBT), polyethylene terephthalate (PET), ethylene acrylic acid, ethylene methacrylic acid, polyethylene methacrylic acid, and mixtures thereof. The composition of the pressure release vent mechanism 36 can also include polymers reinforced with metal, as well as a single layer or a multi-layer laminate of metals or polymers or both. For example, the single layer can be a metal foil, preferably aluminum foil, that is substantially impermeable to water, carbon dioxide and electrolyte, or a non-metallized film of a polymer coated with a layer of oxidized material that prevents vapor transmission, such as, for example SiOₓ or Al₂Oₓ. The pressure release vent mechanism 36 can furthermore contain an adhesive layer that contains a contact-bonding adhesive material, for example polyurethane, or a heat, pressure and/or ultrasonically activated material, for example low density polyolefins. Alternatively, these or other adhesives or sealant materials can be separately applied to a portion of the pressure release vent member (e.g., the outer periphery coming into contact with contact member 38, a retainer 88, or both for enhancing the seal within the collector assembly. A preferred laminar vent construction would have four layers consisting of oriented polypropylene, polyethylene, aluminum foil and low density polyethylene.

Regardless of the composition, the pressure release vent mechanism 36 should be chemically resistant to the electrolyte contained in the cell 10 and should have a low vapor transmission rate (VTR) to provide a low rate of weight loss for the cell 10 over a broad range of ambient temperatures. For example, if the pressure release vent mechanism 36 is metal which is impervious to vapor transmission, the VTR through the thickness of the pressure release mechanism 36 is substantially zero. However, the pressure release vent mechanism 36 can include at least one layer of vapor-permeable material, for example polymeric materials, as described above, that can function, for example, as an adhesive or as an elastomeric layer to achieve a desired seal between the pressure release vent mechanism 36 and another cell component, preferably contact member 38.

The predetermined release pressure, or the pressure at which the pressure release vent mechanism 36 is intended to rupture, is a function of its physical properties (e.g., strength), its physical dimensions (e.g., thickness) and the area of the opening, for example as defined by the contact member 38 illustrated in FIG. 3, and the opening defined by the PTC device, whichever is smaller. The greater the exposed area of the pressure release vent mechanism 36, the lower the predetermined release pressure will be due to the greater collective force exerted by the internal gases of the electrochemical battery cell 10. Consequently, adjustments may be made to any of these variables in order to engineer an end assembly with a vent member without departing from the principles of the invention.

Depending upon the exposed area of the vent mechanism 36, the thickness of the pressure release foil-type vent member can be less than about 0.254 mm (0.010 inch), and in some embodiments can range from about 0.0254 mm (0.001 inch) to about 0.127 mm (0.005 inch), and in yet other embodiments the thickness can range from about 0.0254 mm (0.001 inch) to about 0.05 mm (0.002 inch). The composition and thickness of the pressure release vent mechanism 36 can be determined by those of ordinary skill in the art, in view of the vapor transmission rate (VTR) and predetermined release pressure requirements.

The pressure release foil-type vent member can include at least one layer of a composition containing metal, polymer, and mixtures thereof. A suitable three-layer laminate that can be used for the pressure release vent member is PET/aluminum/EAA copolymer available as LIQUIFLEX® Grade 05396 35C-501C from Curwood of Oshkosh, Wis., USA. A suitable four layer material of oriented PP/PE/aluminum/LDPE is FR-2175 from Ludlow Coated Products of Columbus, Ga., USA, which is a wholly-owned subsidiary of Tyco International, Ltd. of Princeton, N.J., USA. A suitable five-layer laminate is PET/PE/Aluminum/PE/LL-DPE available as BF-48 also from Ludlow Coated Products of Columbus, Ga., USA. However, as noted above, any combination of laminates for polypropylene, polyethylene, non-metallized polymeric films coated with a layer of oxidized material that prevents vapor transmission (for example, SiOₓ or Al₂Oₓ) and/or aluminum-based foils are also specifically contemplated.

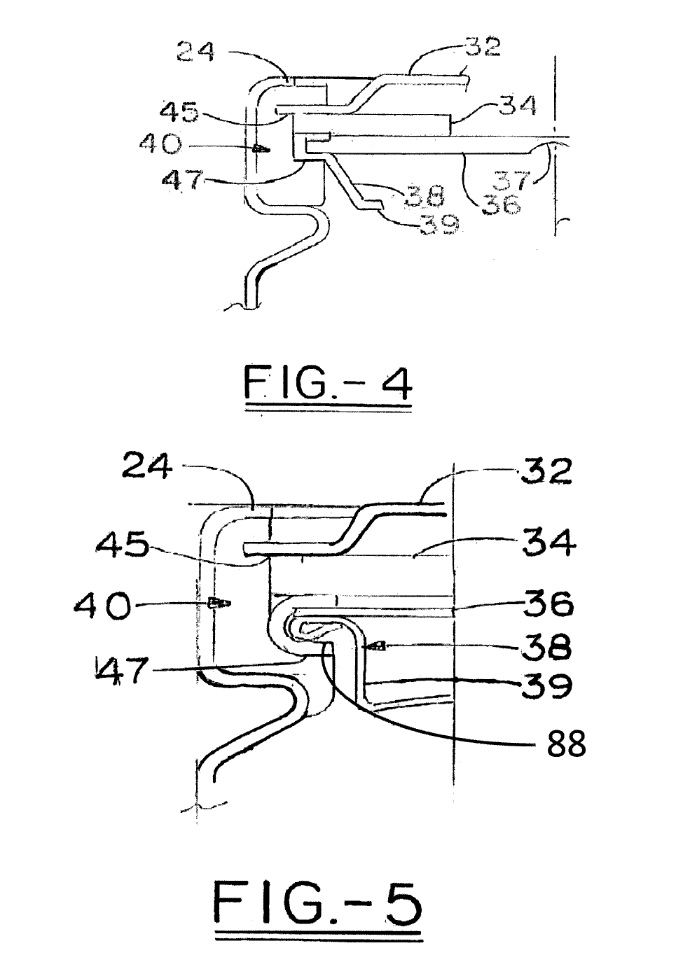

A coined vent 37 may also be used, as shown in FIG. 4. Such vents include at least one layer of a composition of a metal, polymer or mixture thereof, as described hereinabove for the foil-type vent, wherein the coined vent member includes a thin rupturable area or cut-out 37 that allows the vent member to rupture when the predetermined internal pressure of a cell is reached.

A preformed end assembly 30 may be produced by insert molding a gasket 40 around the periphery of any of the vent mechanisms 36 described above. Optionally, contact members 38, 50 and/or retainer 88 may also be included. A benefit of insert molding at least the vent mechanism 36 within the seal member is that it is not necessary to deform the seal member during cell assembly. A further advantage of insert molding is that seal members can be formed having relatively deep features on the inner surface of the seal member. A typical insert molding method such as rotary or stack molding can be utilized, although other methods are also available.

During molding of the seal member, at least the vent member and, optionally, the periphery of the contact member and/or retainer, are encapsulated by a portion of the seal member that is formed around the periphery of the vent member and optionally the contact member. During the insert molding process, the insert (in this case, at least the preformed vent member and the optional the contact member(s) and/or retainer) are placed in the mold prior to introduction of the molding material utilized to form the seal member. A portion of the seal member is then molded around the inserted part, such as the vent member and/or vent member composite including the contact member. The resulting product is the preformed seal assembly comprising the seal member/vent member composite comprising the combined seal member and vent member, and optionally the contact member or the contact member and the retainer. In this arrangement, the insert must be able to withstand the mold and melt temperatures required to properly mold the plastic gasket.

The negative electrode 62 comprises a strip of electrochemically active material. In a preferred embodiment, lithium metal, sometimes referred to as lithium foil, is used. The composition of the lithium can vary, though for battery grade lithium the purity is always high. The lithium can be alloyed with other metals, such as aluminum, to provide the desired cell electrical performance. Battery grade lithium-aluminum foil containing 0.5 weight percent aluminum is available from Chemetall Foote Corp., Kings Mountain, N.C., USA. Additional or alternative negative electrode materials are possible, including virtually any intercalable lithium-containing compositions, which are typically coated onto a current collector a manner similar to the processes described with respect to the cathode material below.

The negative electrode may have a non-consumable current collector in some embodiments, within or on the surface of the metallic lithium. When the negative electrode includes a non-consumable current collector, it may be made of copper, nickel or other conductive metals or alloys, so long as they are stable inside the cell.

The negative electrode may be free of a separate current collector, such that only the foil serves as a current collector. This is feasible in lithium and lithium alloys due to their relatively high conductivity alloy. By not utilizing a current collector, more space is available within the container for other components, such as active materials. Providing a cell without a negative electrode current collector can also reduce cell cost.

An electrical lead preferably connects the anode or negative electrode to the cell container. This may be accomplished embedding an end of the lead within a portion of the negative electrode or by simply pressing a portion such as an end of the lead onto the surface of the lithium foil. The lithium or lithium alloy has adhesive properties and generally at least a slight, sufficient pressure or contact between the lead and electrode will weld the components together. In one preferred embodiment, the negative electrode is provided with a lead prior to winding into a jelly-roll configuration. For example, during production, a band comprising at least one negative electrode consisting of a lithium or lithium alloy is provided at a lead connecting station whereat a lead is welded onto the surface of the electrode at a desired location. The tabbed electrode is subsequently processed so that the lead is coined, if desired, in order to shape the free end of the lead not connected to the electrode. Subsequently, the negative electrode is combined with the remaining desired components of the electrode assembly, such as the positive electrode and separator, and wound into a jelly-roll configuration. Preferably after the winding operation has been performed, the free negative electrode lead end is further processed, by bending into a desired configuration prior to insertion into the cell container.

The electrically conductive negative electrode lead has a sufficiently low resistance in order to allow sufficient transfer of electrical current through the lead and have minimal or no impact on service life of the cell. The desired resistance can be achieved by increasing the width and the thickness of the tab.

The positive electrode 64 is generally in the form of a strip that comprises a current collector and a mixture that includes one or more electrochemically active materials, usually in particulate form. Iron disulfide (FeS₂) is a preferred active material for primary battery applications. The positive electrode may contain one or more additional active materials, depending on the desired cell electrical and discharge characteristics. Such positive electrode material include Bi₂O₃, C₂F, CFₓ, (CF)ₙ, CoS₂, CuO, CuS, FeS, FeCuS₂, MnO₂, Pb₂Bi₂O₅ and S. More preferably, the active material for a Li/FeS₂ cell positive electrode comprises at least 95 weight percent FeS₂ coated onto a metal foil current collector. FeS₂ having a purity level of at least 95 weight percent is available from Chemetall GmbH, Vienna, Austria; Washington Mills, North Grafton, Mass., USA; and Kyanite Mining Corp., Dillwyn, Va., USA. Alternatively, any number of materials compatible with secondary systems may also be used.

Typically, the positive and/or negative electrode mixtures may contain other materials. A binder is generally used to hold the particulate materials together and adhere the mixture to the current collector. One or more conductive materials such as metal, graphite and carbon black powders may be added to provide improved electrical conductivity to the mixture. The amount of conductive material used can be dependent upon factors such as the electrical conductivity of the active material and binder, the thickness of the mixture on the current collector and the current collector design. Small amounts of various additives may also be used to enhance positive electrode manufacturing and cell performance. A preferred cathode formulations for LiFeS₂ cells can be found in U.S. patent application Ser. No. 12/253,516, filed on Oct. 12, 2008, and U.S. Pat. No. 6,849,360, both of which are incorporated by reference herein.

The current collector may be disposed within or imbedded into the positive electrode surface, or the positive electrode mixture may be coated onto one or both sides of a thin metal strip. Aluminum is a commonly used material. The current collector may extend beyond the portion of the positive electrode containing the positive electrode mixture. This extending portion of the current collector can provide a convenient area for making contact with the electrical lead connected to the positive terminal. It is desirable to keep the volume of the extending portion of the current collector to a minimum to make as much of the internal volume of the cell available for active materials and electrolyte.

A preferred method of making positive electrodes is to roll coat a slurry of active material mixture materials in a solvent (e.g., trichloroethylene) onto both sides of a sheet of aluminum foil, dry the coating to remove the solvent, calender the coated foil to compact the coating, slit the coated foil to the desired width and cut strips of the slit positive electrode material to the desired length. It is desirable to use positive electrode materials with small particle sizes to minimize the risk of puncturing the separator.

The separator 66 is a thin microporous membrane that is ion-permeable and electrically nonconductive. It is capable of holding at least some electrolyte within the pores of the separator. The separator is disposed between adjacent surfaces of the negative electrode and positive electrode to electrically insulate the electrodes from each other. Portions of the separator may also insulate other components in electrical contact with the cell terminals to prevent internal short circuits. Edges of the separator often extend beyond the edges of at least one electrode to insure that the negative electrode and positive electrode do not make electrical contact even if they are not perfectly aligned with each other. However, it is desirable to minimize the amount of separator extending beyond the electrodes.

To provide good high power discharge performance it is desirable that the separator have the characteristics (pores with a smallest dimension of at least 0.005 μm and a largest dimension of no more than 5 μm across, a porosity in the range of 30 to 70 percent, an area specific resistance of from 2 to 15 ohm-cm² and a tortuosity less than 2.5) disclosed in U.S. Pat. No. 5,290,414, issued Mar. 1, 1994, and hereby incorporated by reference.

Suitable separator materials should also be strong enough to withstand cell manufacturing processes as well as pressure that may be exerted on the separator during cell discharge without tears, splits, holes or other gaps developing that could result in an internal short circuit. To minimize the total separator volume in the cell, the separator should be as thin as possible, preferably less than 25 μm thick, and more preferably no more than 22 μm thick, such as 20 μm or 16 μm. A high tensile stress is desirable, preferably at least 800, more preferably at least 1000 kilograms of force per square centimeter (kgf/cm²). For an FR6 type cell the preferred tensile stress is at least 1500 kgf/cm² in the machine direction and at least 1200 kgf/cm² in the transverse direction, and for a FR03 type cell the preferred tensile strengths in the machine and transverse directions are 1300 and 1000 kgf/cm², respectively. Preferably the average dielectric breakdown voltage will be at least 2000 volts, more preferably at least 2200 volts and most preferably at least 2400 volts. The preferred maximum effective pore size is from 0.08 μm to 0.40 μm, more preferably no greater than 0.20 μm. Preferably the BET specific surface area will be no greater than 40 m²/g, more preferably at least 15 m²/g and most preferably at least 25 m²/g. Preferably the area specific resistance is no greater than 4.3 ohm-cm², more preferably no greater than 4.0 ohm-cm², and most preferably no greater than 3.5 ohm-cm². These properties are described in greater detail in United States Patent Publication No. 20050112462, which is also hereby incorporated by reference.

Separator membranes for use in lithium primary and secondary batteries are often polymeric separators made of polypropylene, polyethylene or ultrahigh molecular weight polyethylene, with polyethylene being preferred. The separator can be a single layer of biaxially oriented microporous membrane, or two or more layers can be laminated together to provide the desired tensile strengths in orthogonal directions. A single layer is preferred to minimize the cost. Suitable single layer biaxially oriented polyethylene microporous separator is available from Tonen Chemical Corp., available from EXXON Mobile Chemical Co., Macedonia, N.Y., USA. Setela F20DHI grade separator has a 20 μm nominal thickness, and Setela 16MMS grade has a 16 μm nominal thickness.

The negative electrode, positive electrode and separator strips are combined together in an electrode assembly. The electrode assembly may be a spirally wound design, such as that shown in FIG. 1, made by winding alternating strips of positive electrode, separator, negative electrode and separator around a mandrel, which is extracted from the electrode assembly when winding is complete. At least one layer of separator and/or at least one layer of electrically insulating film (e.g., polypropylene) is generally wrapped around the outside of the electrode assembly. This serves a number of purposes: it helps hold the assembly together and may be used to adjust the width or diameter of the assembly to the desired dimension. The outermost end of the separator or other outer film layer may be held down with a piece of adhesive tape or by heat sealing. The negative electrode can be the outermost electrode, as shown in FIG. 1, or the positive electrode can be the outermost electrode. Either electrode can be in electrical contact with the cell container, but internal short circuits between the outmost electrode and the side wall of the container can be avoided when the outermost electrode is the same electrode that is intended to be in electrical contact with the can.

In one or more embodiments of the present invention, the electrode assembly is formed with the positive electrode having electrochemically active material selectively deposited thereon for improved service and more efficient utilization of the electrochemically active material of the negative electrode. Non-limiting examples of selectively deposited configurations of electrochemically active material on the positive electrode and further, an electrochemical cell, including a positive container, are set forth in United States Patent Publication Nos. 20080026288 and 20080026293, both fully herein incorporated by reference.

Rather than being spirally wound, the electrode assembly may be formed by folding the electrode and separator strips together. The strips may be aligned along their lengths and then folded in an accordion fashion, or the negative electrode and one electrode strip may be laid perpendicular to the positive electrode and another electrode strip and the electrodes alternately folded one across the other (orthogonally oriented), in both cases forming a stack of alternating negative electrode and positive electrode layers.

The electrode assembly is inserted into the housing container. In the case of a spirally wound electrode assembly, whether in a cylindrical or prismatic container, the major surfaces of the electrodes are perpendicular to the side wall(s) of the container (in other words, the central core of the electrode assembly is parallel to a longitudinal axis of the cell). Folded electrode assemblies are typically used in prismatic cells. In the case of an accordion-folded electrode assembly, the assembly is oriented so that the flat electrode surfaces at opposite ends of the stack of electrode layers are adjacent to opposite sides of the container. In these configurations the majority of the total area of the major surfaces of the negative electrode is adjacent the majority of the total area of the major surfaces of the positive electrode through the separator, and the outermost portions of the electrode major surfaces are adjacent to the side wall of the container. In this way, expansion of the electrode assembly due to an increase in the combined thicknesses of the negative electrode and positive electrode is constrained by the container side wall(s).

A nonaqueous electrolyte, containing water only in very small quantities as a contaminant (e.g., no more than about 500 parts per million by weight, depending on the electrolyte salt being used), is used in the preferred electrochemical cells of the invention. Any electrolyte suitable may be used, including alkaline solutions, nonaqueous organics and solid-state polymer electrolytes. In the event an organic solvent or solvents are used, examples of suitable salts include lithium bromide, lithium perchlorate, lithium hexafluorophosphate, potassium hexafluorophosphate, lithium hexafluoroarsenate, lithium trifluoromethanesulfonate and lithium iodide; and suitable organic solvents include one or more of the following: dimethyl carbonate, diethyl carbonate, methylethyl carbonate, ethylene carbonate, propylene carbonate, 1,2-butylene carbonate, 2,3-butylene carbonate, methyl formate, γ-butyrolactone, sulfolane, acetonitrile, 3,5-dimethylisoxazole, n,n-dimethyl formamide and ethers. The salt/solvent combination will provide sufficient electrolytic and electrical conductivity to meet the cell discharge requirements over the desired temperature range. Ethers are often desirable because of their generally low viscosity, good wetting capability, good low temperature discharge performance and good high rate discharge performance. This is particularly true in Li/FeS₂ cells because the ethers are more stable than with MnO₂ positive electrodes, so higher ether levels can be used. Suitable ethers include, but are not limited to acyclic ethers such as 1,2-dimethoxyethane, 1,2-diethoxyethane, di(methoxyethyl)ether, triglyme, tetraglyme and diethyl ether; and cyclic ethers such as 1,3-dioxolane, tetrahydrofuran, 2-methyl tetrahydrofuran and 3-methyl-2-oxazolidinone.

Methods for assembly of the electrochemical cells of the present invention include inserting the electrode assembly and preferably an insulating member such as a cone into the cell container. An initial bead is formed in the sidewall of container. The bead is formed in one embodiment by pressing a forming wheel against the sidewall of the container in the area it is desired to form the bead while the can is rotated around its axis . Electrolyte is dispensed into the container prior to insertion of the end assembly into container, when a foil vent is utilized. Alternatively, if a ball vent is utilized in end assembly, the electrolyte can be added prior to internal sealing of the cell with the ball of the ball vent. The peripheral portions of the end assembly, which may be held together by interference fit, are seated on the upper wall of the initial bead formed. Cell closing operations may include reducing the diameter of the upper sidewall by a redraw or collet process. After diameter reduction, the upper end of the container is also folded inwardly to form a crimped end and axial forces are applied between the bead and crimped end. Radial compression is preferably maintained on at least the upper sidewall during crimping of the upper end of the container.

The results of some embodiments of the cell forming and closing processes are illustrated in the drawings, although other processes consistent with other embodiments of this invention are possible. The shape of the parts and the closing processes should insure that the desired interfaces between the seal member and the container; seal member and the PTC device; and the seal member and the vent member outer diameter are all established and maintained throughout the useful life of the battery.

The above description is particularly relevant to cylindrical Li/FeS₂ cells, such as FR6 and FR03 types (as defined in International Standards IEC 60086-1 and IEC 60086-2, published by the International Electrotechnical Commission, Geneva, Switzerland). However, other embodiments can be adapted to other cell sizes, shapes and chemistries. For example, other electrode assembly shapes, housing structures, end assemblies, pressure relief vents, closing processes and the like can be implemented in combination with a dual wall gasket. Other cell chemistries can include primary or rechargeable cylindrical cells with nominal voltages of 1.5 or more, such as Li/SO₂, Li/AgCl, Li/V₂O₅, Li/MnO₂, Li/Bi₂O₃, various lithium composites common to “lithium-ion” systems, nickel metal hydride, alkaline-based and other similar chemistries can be utilized.

The electrode assembly configuration can also vary. For example, it can have spirally wound electrodes, as described above, folded electrodes, or stacks of strips (e.g., flat plates). Also, while the embodiments above describe the use of a single PTC, any number of PTCs may be accommodated according to this invention.

In view of the foregoing, an electrochemical cell comprising any combination of the following features is contemplated:
a cylindrical container having a sidewall and an open end;
an end assembly fitted within the open end of the container, said end assembly comprising a PTC device, a vent assembly and a cover,
an electrode assembly and an electrolyte disposed within the container, said electrode assembly in electrical contact with the end assembly;
an annular gasket having an axial outer sidewall portion with a constant diameter and a stepped, axial inner sidewall portion forming a seal with the end assembly, said stepped axial inner sidewall defined by: (i) an upper portion having a first diameter, (ii) a lower portion having a second diameter that is not the same to the first diameter, (iii) a first radial shoulder disposed between the upper portion and the lower portion and (iv) a second radial shoulder offset from the first radial shoulder;
wherein an edge of the open end of the container is crimped over a portion of the gasket, a first portion of the end assembly is seated on the first radial shoulder, second portion of the end assembly is seated on the second radial shoulder and the PTC device engages the stepped axial inner sidewall but is not seated directly on the first and second radial shoulders;
wherein the vent assembly includes a rollback cover;
wherein the annular gasket further comprises an upper terminal flange that is crimped radially inward so as to define a third diameter that is not the same as the first diameter;
wherein the first diameter is greater than the second diameter;
wherein the gasket is insert molded with the end assembly;
wherein the gasket is insert molded to a portion of the vent assembly;
wherein the first diameter is concentrically disposed around the cover and the second diameter is concentrically disposed around at least one of: a portion of the PTC device and a portion of the vent assembly;
wherein the first radial shoulder has a groove engaging a portion of the end assembly;
wherein the cylindrical container has an annular bead proximate to the open end;
wherein the gasket is seated on the annular bead;
wherein the gasket further comprises a lower terminal flange;
wherein the second radial shoulder has a groove engaging a portion of the end assembly; and/or
wherein the second radial shoulder is formed by the lower terminal flange and wherein the lower terminal flange defines a third diameter which is less than the second diameter;

An electrochemical cell comprising one or more of the following features is also contemplated:
a cylindrical container having a sidewall with an annular bead and an open end;
an end assembly fitted within the open end of the container, said end assembly comprising a PTC device, a vent and a cover;
a contact member establishing an electrical connection between an electrode disposed within the container and the end assembly;
a dual wall gasket;
wherein the open end of the container is crimped over the gasket and cover to create a primary axial compression force;
wherein the dual wall gasket and the PTC device are arranged to prevent the PTC device from being exposed to the primary axial compression force;
wherein the end assembly further comprises a retainer, said retainer receiving a portion of the vent and a portion the contact member; and/or
wherein the contact member is a spring.

Finally, a method for sealing a cylindrical electrochemical cell distinguished by any combination of the following steps is contemplated:
providing a cylindrical container having an open end;
disposing an electrode assembly and an electrolyte inside of the container;
forming an annular bead in the open end of the container;
seating an annular gasket in the open end of the container proximate to the annular bead, wherein the annular gasket has a flange, a first radial shoulder and a second radial shoulder;
seating a vent assembly on the second radial shoulder of the gasket;
disposing a PTC device concentrically within the gasket;
seating a cover on the first radial shoulder of the gasket;
crimping the open end of the container over a portion the flange so that: (i) the annular bead, the flange of the gasket, the cover and the first shoulder of the gasket all cooperate to create a primary axial compression force and (ii) the second shoulder of the gasket and the PTC device are not exposed to the primary axial compression force;
wherein the cover is seated on the first radial shoulder in manner that generates radial compression force on the gasket and an inner sidewall of the cylindrical container;
wherein the vent assembly is seated on the second radial shoulder in manner that generates radial compression force on the gasket and an inner sidewall of the cylindrical container;
wherein the vent assembly includes a rollback cover;
wherein the flange is folded over the cover so as to extend radially inward so that a terminal edge of the flange is closer to a central axis of the electrochemical cell as compared to an outermost circumference of the vent assembly;
wherein the vent assembly cooperates with the second radial shoulder and the cover in manner that generates a secondary axial compression force, said secondary axial compression force being less than the primary axial compression force; and/or
wherein the vent assembly is seated on the second radial shoulder by insert molding the gasket with the vent assembly.

It will be understood by those who practice the invention and those skilled in the art that various modifications and improvements may be made to the invention without departing from the spirit of the disclosed concepts. The scope of protection afforded is to be determined by the claims and by the breadth of interpretation allowed by law.

What is claimed is:

1. An electrochemical cell comprising:
a cylindrical container having a sidewall and an open end;
an end assembly fitted within the open end of the container, said end assembly comprising a PTC device, a vent assembly and a cover,
an electrode assembly and an electrolyte disposed within the container, said electrode assembly in electrical contact with the end assembly; and
an annular gasket having an axial outer sidewall portion with a constant diameter and a stepped, axial inner sidewall portion forming a seal with the end assembly, said stepped axial inner sidewall defined by: (i) an upper portion having a first diameter, (ii) a lower portion having a second diameter that is not the same to the first diameter, (iii) a first radial shoulder disposed between the upper portion and the lower portion and (iv) a second radial shoulder offset from the first radial shoulder; and
wherein an edge of the open end of the container is crimped over a portion of the gasket, a first portion of the end assembly is seated on the first radial shoulder, second portion of the end assembly is seated on the second radial shoulder and the PTC device engages the stepped axial inner sidewall but is not seated directly on the first and second radial shoulders.

2. The electrochemical cell of claim 1, wherein the vent assembly includes a rollback cover.

3. The electrochemical cell of claim 1, wherein the annular gasket further comprises an upper terminal flange that is crimped radially inward so as to define a third diameter that is not the same as the first diameter.

4. The electrochemical cell of claim 3, wherein the first diameter is greater than the second diameter.

5. The electrochemical cell of claim 1, wherein the gasket is insert molded with the end assembly.

6. The electrochemical cell of claim 5, wherein the gasket is insert molded to a portion of the vent assembly.

7. The electrochemical cell of claim 1, wherein the first diameter is concentrically disposed around the cover and the second diameter is concentrically disposed around at least one of: a portion of the PTC device and a portion of the vent assembly.

8. The electrochemical cell of claim 1, wherein the first radial shoulder has a groove engaging a portion of the end assembly.

9. The electrochemical cell of claim 1, wherein the first diameter is greater than the second diameter.

10. The electrochemical cell of claim 1, wherein the cylindrical container has an annular bead proximate to the open end.

11. The electrochemical cell of claim 10, wherein the gasket is seated on the annular bead.

12. The electrochemical cell of claim 1, wherein the gasket further comprises a lower terminal flange.

13. The electrochemical cell of claim 12, wherein the second radial shoulder has a groove engaging a portion of the end assembly.

14. The electrochemical cell of claim 12, wherein the second radial shoulder is formed by the lower terminal flange and wherein the lower terminal flange defines a third diameter which is less than the second diameter.

15. The electrochemical cell of claim 14, wherein the first diameter is greater than the second diameter.

16. The electrochemical cell of claim 15, wherein the annular gasket further comprises an upper terminal flange that is crimped radially inward so as to define a third diameter that is not the same as the first diameter.

17. An electrochemical cell comprising:
a cylindrical container having a sidewall with an annular bead and an open end;
an end assembly fitted within the open end of the container, said end assembly comprising a PTC device, a vent and a cover;
a contact member establishing an electrical connection between an electrode disposed within the container and the end assembly;
a dual wall gasket;
wherein the open end of the container is crimped over the gasket and cover to create a primary axial compression force; and
wherein the dual wall gasket and the PTC device are arranged to prevent the PTC device from being exposed to the primary axial compression force.

18. The electrochemical cell of claim 17, wherein the end assembly further comprises a retainer, said retainer receiving a portion of the vent and a portion the contact member.

19. The electrochemical cell of claim 17, wherein the contact member is a spring.

20. A method for sealing an electrochemical cell comprising:
providing a cylindrical container having an open end;
disposing an electrode assembly and an electrolyte inside of the container;
forming an annular bead in the open end of the container;
seating an annular gasket in the open end of the container proximate to the annular bead, wherein the annular gasket has a flange, a first radial shoulder and a second radial shoulder;
seating a vent assembly on the second radial shoulder of the gasket;
disposing a PTC device concentrically within the gasket;
seating a cover on the first radial shoulder of the gasket; and
crimping the open end of the container over a portion the flange so that: (i) the annular bead, the flange of the gasket, the cover and the first shoulder of the gasket all cooperate to create a primary axial compression force and (ii) the second shoulder of the gasket and the PTC device are not exposed to the primary axial compression force.

21. The method of claim 20, wherein the cover is seated on the first radial shoulder in manner that generates radial compression force on the gasket and an inner sidewall of the cylindrical container.

22. The method of claim 20, wherein the vent assembly is seated on the second radial shoulder in manner that generates radial compression force on the gasket and an inner sidewall of the cylindrical container.

23. The method of claim 22, wherein the vent assembly includes a rollback cover.

24. The method of claim 20, wherein the flange is folded over the cover so as to extend radially inward so that a terminal edge of the flange is closer to a central axis of the electrochemical cell as compared to an outermost circumference of the vent assembly

25. The method of claim 20, wherein the vent assembly cooperates with the second radial shoulder and the cover in manner that generates a secondary axial compression force, said secondary axial compression force being less than the primary axial compression force.

26. The method of claim 25, wherein the vent assembly is seated on the second radial shoulder in a manner that generates radial compression force on the gasket and an inner sidewall of the cylindrical container.

27. The method of claim 20, wherein the vent assembly is seated on the second radial shoulder by insert molding the gasket with the vent assembly.
